(19) United States
(12) Patent Application Publication
(10) Pub. No.: US 2013/0145844 A1
(43) Pub. Date: Jun. 13, 2013

(54) SENSOR MODULE AND PRODUCTION METHOD OF A SENSOR MODULE

(71) Applicants: Jan-Erik Hauschel, Apolda (DE); Thorsten Knittel, Pentling (DE); Stefan Pesahl, Saal A.D. Donau (DE); Willibald Reitmeier, Hohenschambach (DE); Andreas Wildgen, Nittendorf (DE)

(72) Inventors: Jan-Erik Hauschel, Apolda (DE); Thorsten Knittel, Pentling (DE); Stefan Pesahl, Saal A.D. Donau (DE); Willibald Reitmeier, Hohenschambach (DE); Andreas Wildgen, Nittendorf (DE)

(73) Assignee: Continental Automotive GmbH, Hannover (DE)

(21) Appl. No.: 13/512,304

(22) PCT Filed: Nov. 23, 2010
(86) PCT No.: PCT/EP2010/068053

§ 371 Date: Oct. 8, 2012

(30) Foreign Application Priority Data
Nov. 26, 2009 (DE) 10 2009 055 717.2

(51) Int. Cl. G01D 11/24

(52) U.S. Cl. CPC G01D 11/245
USPC 73/431; 29/592.1

(57) ABSTRACT

A sensor module and method for producing the sensor module including a chip carrier and a sensor chip disposed thereon. The sensor module includes at least one partial cover having a recess on a second face of the chip carrier, such that heat from the chip carrier and/or the sensor chip can be dissipated to the recess.

### CROSS REFERENCE TO RELATED APPLICATIONS

This is a U.S. national stage of application No. PCT/EP2010/068053, filed on 23 Nov. 2010. Priority is claimed on Germany Application No. 10 2009 055 717.2 filed 26 Nov. 2009, the content of which is incorporated here by reference.

### BACKGROUND OF THE INVENTION

1. Field of the Invention

The present invention relates to a sensor module and a production method for a sensor module.

2. Description of Prior Art

Sensor modules typically have a chip carrier, referred to as a lead frame, and a sensor chip on the chip carrier. The sensor chip is electrically connected to the chip carrier. The sensor module is at least partially embedded in a plastic material to protect the sensor chip from external influences.

Such a sensor module and a method for producing this sensor module are described in DE 10 2007 057 903 A1. The sensor module has a sensor chip applied to a conductor grid, which has a sensor area. The sensor chip is fastened on a forked retaining section of the conductor grid so that the sensor area is on the side of the sensor chip facing toward the conductor grid. Because of the forked design of the conductor grid, the conductor grid is only located on the outer sides of the sensor chip.

A cover of this sensor module is formed in a transfer molding procedure. The cover material flows into an injection mold at a pressure below 10 bar. After the filling of the injection mold, a post-compression procedure can be performed, in which the cover material is placed under a pressure between 50 and 100 bar to press remaining air out of the injection mold.

Heat arises in operation of the sensor module, in particular on elements of the sensor module supplied with power. A disadvantage of the above sensor module is that the cover material covers a majority of the sensor module. This results in worse heat dissipation from the sensor module into the surroundings in comparison to a non-covered sensor module. The worsened heat dissipation may have the effect that the durability and the measurement precision of the sensor module are decreased in comparison to a non-covered sensor module.

U.S. Pat. No. 5,369,550 describes a method for cooling a housing for an integrated circuit. The housing is equipped with through holes for cooling, which extend completely from the bottom side to the top side through the housing.

U.S. Pat. No. 6,670,692 B1 describes an arrangement of multiple metal layers on an integrated circuit in a chip housing. The metal layers fulfill the function of an integrated smoothing capacitor and can be used for the removal of heat generated by the integrated circuit.

### SUMMARY OF THE INVENTION

An object of one embodiment of the present invention is to provide a sensor module optimized in comparison to the prior art in regard to heat dissipation of the sensor module and to specify a corresponding production method.

A sensor module according to one embodiment of the invention comprises a chip carrier (lead frame) having a first side and a second side opposite to the first side, a sensor chip arranged on the first side of the chip carrier, which can be supplied with electricity by the chip carrier, while the second side of the chip carrier has at least a partial cover having a recess, so that heat can be dissipated from the chip carrier and/or sensor chip at the recess.

A sensor module comprises a chip carrier (lead frame) having a first side and a second side. The first side and the second side are opposite to one another. A sensor chip is at least partially arranged on the first side of the chip carrier. The sensor chip is supplied with electricity via the chip carrier. Furthermore, the chip carrier can be electrically connected to the sensor chip in such a manner that it relays electrical signals of the sensor chip. The chip carrier can be a conductor grid or a conductor plate, for example. An electrical connection between sensor chip and chip carrier can be implemented by bond wires. The sensor chip is, for example, a differential pressure sensor chip or a mass flow sensor chip. In particular, it is a sensor chip having two sensor regions, which are arranged on opposing sides of the sensor chip.

A cover is at least partially located on the second side of the chip carrier. This cover has a recess, so that heat can be dissipated from the chip carrier and/or the sensor chip at the recess. The recess can be rectangular or round. Furthermore, multiple recesses extending parallel to one another can be provided. In particular, the recess is a clearance. The recess is arranged at an arbitrary point on the second side of the chip carrier opposite to the sensor chip.

An advantage of this sensor module is that heat dissipation is improved in comparison to a sensor module according to the prior art because of the recess. This results in extended durability and increased measurement precision in comparison to typical sensor modules.

In one embodiment, the chip carrier has an opening in a region of the recess. Because of the opening, the heat dissipation from the chip carrier and/or sensor module can be improved in comparison to a sensor module without the opening.

The opening is advantageously part of a first channel, which extends in particular to an active component arranged on the chip carrier. The active component is a component supplied with power, for example, a coil. Heat can be dissipated in a targeted manner via the chip carrier from the active component using the first channel.

The first channel is used to assist the heat dissipation from the sensor module, in particular from the active component of the sensor module. In the case of a plurality of active components, the first channel can either branch or a plurality of first channels can be provided corresponding to a number of active components.

In a preferred embodiment, a cooling structure is arranged in the recess on the second side of the sensor chip. The cooling structure can be any arbitrary cooling device. For example, it can be a housing of a sensor module or a cooling body. The cooling structure assists the heat dissipation from the chip carrier and/or sensor chip in addition to the recess. In particular, the cooling structure can be cooling ribs.

Furthermore, it is advantageous if the cover of the sensor module has a flow guiding device on a surface of the sensor module. Heat can be dissipated on the surface of the sensor module using the flow guiding device. In particular, the flow guiding device is formed on a surface of the sensor module. The surface is opposite to the second side of the chip carrier. In this way, heat can be dissipated on a first side of the sensor module by the recess and can be dissipated on a second side of the sensor module by the flow guiding device.

In particular, the flow guiding device can be a flow guiding channel, formed by the cover, on the surface of the sensor module. Because of the flow guiding channel, targeted guiding of a cooling medium, for example, air, can occur via the sensor module. This additionally improves the heat dissipation in comparison to a sensor module having recess.

In one preferred embodiment, the sensor module has a second channel extending between the sensor chip and the first side of the chip carrier. Using the second channel a side of the sensor chip facing toward the first side of the chip carrier is connectable to the surroundings of the sensor module. The sensor chip assumes in particular the task of a wall of the second channel. The second channel can be formed by an embossment in the chip carrier and can be led along the chip carrier to a connection side of the sensor module.

An advantage of the sensor module having a second channel is that a medium to be measured reaches the sensor chip via the second channel because of the arrangement of chip carrier and sensor chip. In particular, a sensor region of the sensor chip is not directly subjected to the medium to be measured. The advantage results therefrom that reduced contamination of the sensor chip occurs, whereby the durability of the sensor module is increased in comparison to typical sensor modules. In addition; a contaminant can result in worsening of the measuring performance of the sensor module. Through the above-described construction of the sensor module having a second channel between sensor chip and chip carrier, a sensor drift because of contaminants is therefore reduced in comparison to typical sensor modules.

In a preferred embodiment, the second channel extends to the second side of the chip carrier, so that a medium can be supplied to the sensor chip from the second side of the chip carrier. For example, the channel can firstly extend over a first section on the first side of the chip carrier between the chip carrier and the sensor chip. After the first section, the channel extends through the chip carrier from the first side to the second side of the chip carrier. A through passage through the chip carrier is formed in this way. An opening of the second channel is located, for example, upon use of this sensor module in a line of a motor vehicle, on a side of the sensor module facing away from the flow.

The opening of the second channel can be provided in the region of the recess or can extend through the cover.

A production method of a covered sensor module, in particular a sensor module according to one embodiment of the invention, has the following: arranging and connecting a sensor chip to a first side of a chip carrier (lead frame), introducing the chip carrier having sensor chip into an injection mold, wherein the injection mold has a device using which a region of a second side of the chip carrier opposite to the first side can be covered, at least partially covering the chip carrier having sensor chip using a cover material, wherein a recess is formed on the second side of the chip carrier because of the region covered by the device, so that heat can be dissipated from the chip carrier and/or sensor chip at the recess.

Firstly, a sensor module having a chip carrier (lead frame) and a sensor chip is provided. The chip carrier has a first side and a second side, which is opposite to the first side. A sensor chip is at least partially arranged on the first side of the chip carrier, which is supplied with electricity via the chip carrier, for example, by bond wires. Furthermore, the chip carrier can be electrically connected to the sensor chip in such a manner that it relays electrical signals of the sensor chip. The chip carrier is a conductor grid or a conductor plate. The sensor chip is a differential pressure sensor chip or a mass flow sensor chip. In particular, it is a sensor chip having two sensor regions, which are arranged on opposing sides of the sensor chip.

The sensor module is introduced into an injection mold. The injection mold is two mold halves, which are equipped with a film. Because of the film, the sensor module is easily removable from the injection mold after a covering step in comparison to an injection mold without film. The injection mold also has a device, using which a region of a second side of the chip carrier opposite to the first side can be covered. For example, the device is a projection which is formed in the injection mold. The projection in particular specifies the shape of the recess or clearance to be formed later.

After the injection mold has been closed, a cover material is introduced into the injection mold, so that the chip carrier having the sensor chip is at least partially covered. The cover material can be a plastic material. Because of the region on the second side of the chip carrier covered by the device, a recess is formed in the cover. As already explained above, the recess is used in particular for heat dissipation from the chip carrier and/or the sensor chip in operation of the sensor module.

A sensor module according to the invention, which has all above-described advantages, is therefore producible using the production method according to the invention.

In one embodiment, the production method comprises : arranging a cooling structure in a region of the recess. Because of the additional cooling structure, the heat dissipation from the chip carrier and/or sensor chip is further improved in comparison to typical sensor modules. The cooling structure can be a cooling body, such as cooling ribs. Furthermore, the recess can be connected to a housing of the sensor module, so that the heat can be dissipated via the housing.

Furthermore, the following step is advantageous: forming a flow guiding device on a surface of the sensor module, so that heat can be dissipated from the surface of the sensor module. Targeted flow guiding of a cooling medium, for example, air, over the surface of the sensor module is implementable using the flow guiding device. The flow guiding device can be formed as a flow guiding channel. This flow guiding channel can be formed on a side of the sensor module opposite to the recess. In this way, heat can be dissipated better in comparison to typical sensor modules on both sides of the sensor module.

If the sensor module has a channel between the first side of the chip carrier and the sensor chip, using which channel a side of the sensor chip facing toward the first side of the chip carrier is connectable to the surroundings of the sensor module, the production method comprises : keeping the channel free during the covering of the sensor module, so that an opening is formed in the cover. In this way, a medium can be supplied via the channel to the sensor chip, in particular a sensor region of the sensor chip, during the later use of the sensor module.

### BRIEF DESCRIPTION OF THE DRAWINGS

The present invention is described in greater detail hereafter with reference to the drawings. Identical reference numerals in the drawings identify identical elements.

In the figures:

FIG. 1 is a schematic view of a sensor module according to the invention;

FIG. 2 is a schematic view of an embodiment of a sensor module according to one embodiment of the invention; and

FIG. 3 shows a schematic method sequence of a production method according to one embodiment of the invention.

### DETAILED DESCRIPTION OF THE PREFERRED EMBODIMENTS

The sensor module according to the invention is used in a motor vehicle. The sensor chip is a differential pressure sensor or a mass flow sensor arranged in an air flow of the motor vehicle.

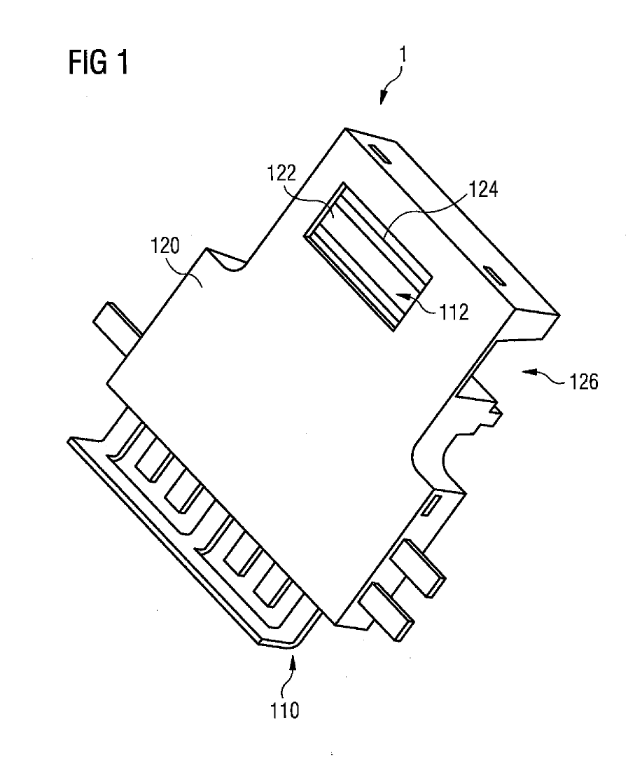

With reference to FIG. 1, a sensor module 1 comprises a chip carrier 110 (lead frame) and a sensor chip arranged on a first side of the chip carrier 110. Furthermore, the sensor module 1 has a cover 120. A region of the cover 120 on a second side of the chip carrier 110 has a recess 122. In the present case, the recess 122 is rectangular. The recess can also be round or extend in the form of multiple parallel slots, however. Heat of the chip carrier 110 and/or the sensor chip can be dissipated at the recess.

In addition, an opening 112 is provided in the chip carrier 110 in the region of the recess 122. This opening 112 can be part of a first channel, which extends to an active component arranged on the chip carrier 110. The active component is a component supplied with power, such as a coil. Heat can be dissipated in a targeted manner from the active component by the first channel. If multiple active components are provided on the chip carrier 110, the channel can have branches to the respective active components. Alternatively, multiple openings each having a first channel to an associated active component are provided in the region of the recess.

In FIG. 1, the sensor module 1 also has a cooling structure 124. The cooling structure 124 are cooling ribs, for example. These assist the heat dissipation from the chip carrier 110 and/or the sensor chip in addition to the recess 122.

For further improvement of the heat dissipation from the sensor module 1, a flow guiding channel 126 formed by the cover 120 is formed on the surface of the sensor module 1. Targeted flow guiding of a cooling medium over the sensor module 1 can occur through the flow guiding channel 126. The heat dissipation is additionally assisted by the cooling medium, for example, air. A flow guiding channel can additionally or alternatively also be formed on the side of the sensor module 1 having the recess 122.

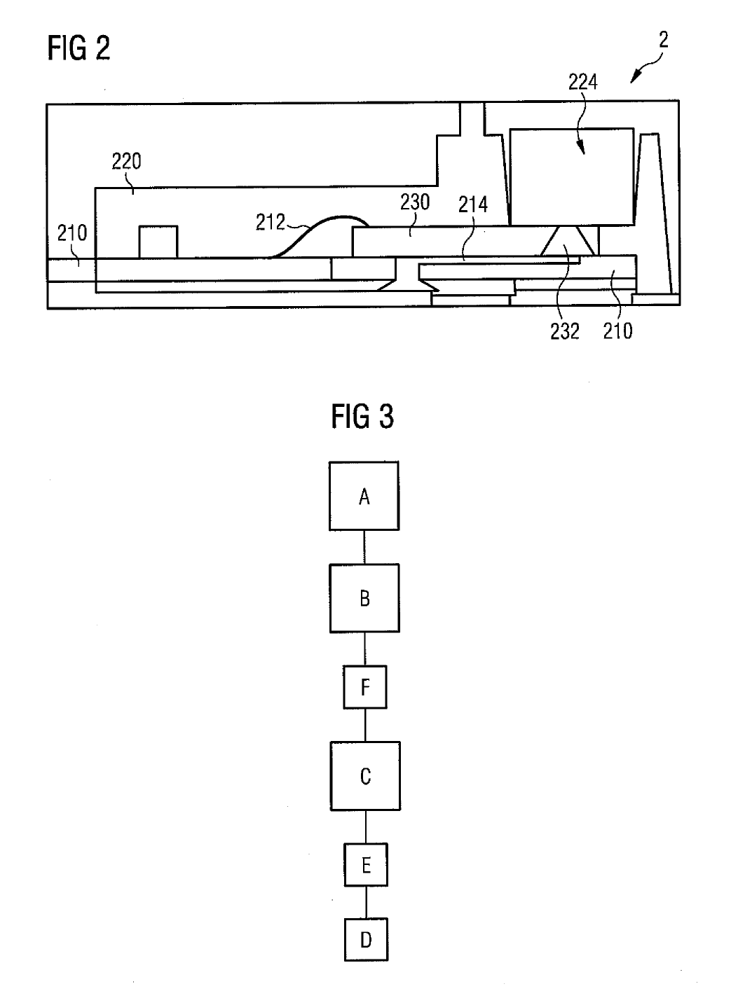

With reference to FIG. 2, an embodiment of a sensor module 2 according to the invention has a chip carrier 210 having a sensor chip 230 arranged thereon. Furthermore, the sensor module 2 has a cover 220 made of a cover material. The cover material is a plastic material. A bond wire 212, which is fastened on the chip carrier 210, is provided for the electrical supply of the sensor chip 230.

A channel 214 is located between the sensor chip 230 and the chip carrier 210. The channel 214 extends from an opening in a second side of the chip carrier 210 to a structural cavity 232 of the sensor chip 230. For this purpose, the channel 214 firstly penetrates, starting from the second side of the chip carrier 210, the chip carrier 210 and then extends along the first side of the chip carrier 210 up to the cavity 232. The sensor chip 230 represents a wall of the channel 214, for example. Furthermore, the channel 214 can have been formed by means of an embossment in the chip carrier 210. A diaphragm can be arranged in the cavity 232 of the sensor chip 230, so that the cavity 232 represents a sensor region of the sensor chip 230. The sensor chip 230 is in particular a differential pressure sensor chip or a mass flow sensor chip. The channel 214 can be provided in addition to the above-described first channel or instead thereof. If the channel 214 is provided in addition to the first channel, the channel 214 is the second channel. The channel 214 can also extend in the direction of the recess, so that the opening of the channel 214 is provided in a region of the recess.

For the further targeted flow dissipation, a flow guiding channel 224 is formed on a surface of the sensor module 2 with the aid of the cover 220. Targeted flow guiding over the sensor chip 230 can occur through the flow guiding channel 224. Alternatively or additionally, a flow guiding channel can also be formed on the opposing second side of the chip carrier, as already described above for FIG. 1.

Furthermore, the embodiment according to FIG. 1 and the embodiment according to FIG. 2 can be combined with one another. The opening 112 in FIG. 1 can therefore be a component of the channel 214 in FIG. 2. Alternatively, both channels to the active components of the sensor module and a channel to a sensor region of the sensor chip can be formed.

With reference to FIG. 3, in a step A, a sensor chip is arranged on a chip carrier and connected thereto. The sensor chip is arranged on the first side of the chip carrier. The chip carrier of the sensor module can have one or more openings on a second side of the chip carrier, which are located in a region of a recess provided later. In particular, one or more openings can be formed in the chip carrier before the sensor chip is arranged on the chip carrier. The one opening or the multiple openings can be part of a channel which extends to active components of the sensor module, as described above.

The sensor module is introduced into an injection mold in a step B. The injection mold has two mold halves, for example, which are covered using a film. Furthermore, the injection mold has a device, using which a region of a second side of the chip carrier opposite to the first side can be covered. If the sensor module has a channel between the first side of the chip carrier and the sensor chip which extends to the second side of the chip carrier, the injection mold then has a further device, using which the channel is kept free during the covering of the sensor module in a step F. In this manner, an opening is formed in the cover, so that the sensor chip is connectable via the channel to the surroundings of the sensor module after the covering.

The at least partial covering of the sensor module using a cover material is performed in step C. A recess is formed on the second side of the chip carrier because of the region covered by the device. Heat can be dissipated from the chip carrier and/or sensor chip with the aid of this recess.

Furthermore, in a step E, a flow guiding device is formed on a surface of the sensor module. Targeted flow guiding of a cooling medium over the sensor module is implementable with the aid of the flow guiding device, as described above for FIGS. 1 and 2.

In a step D, a cooling structure is arranged in a region of the recess. For example, the cooling structure are cooling ribs, as also described above.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A sensor module comprising:
a chip carrier having a first side and a second side opposite to the first side;
a sensor chip arranged on the first side of the chip carrier supplied with electricity by the chip carrier;
at least a partial cover arranged on the second side of the chip carrier; and
a recess in the cover arranged proximate to the sensor chip on the second side of the chip carrier configured to dissipate from at least one of the chip carrier and the sensor chip.

15. The sensor module as claimed in claim 14, wherein the chip carrier has an opening in a region of the recess.

16. The sensor module as claimed in claim 15, wherein the opening is a part of a first channel that extends to an active component arranged on the chip carrier so that heat is dissipated from the active component via the first channel.

17. The sensor module as claimed in claim 14, further comprising:
a cooling structure arranged in the recess.

18. The sensor module as claimed in claim 17, wherein the cooling structure comprises cooling ribs.

19. The sensor module as claimed in claim 14, wherein the cover has a flow guiding device on a surface of the sensor module configured to dissipate heat on the surface of the sensor module.

20. The sensor module as claimed in claim 19, wherein the flow guiding device is a flow guiding channel formed by the cover on the surface of the sensor module.

21. The sensor module as claimed in claim 16, further comprising:
a second channel extending between the sensor chip and the first side of the chip carrier,
wherein the second channel connects a side of the sensor chip facing toward the first side of the chip carrier to a surrounding of the sensor module.

22. The sensor module as claimed in claim 21, wherein the second channel extends to the second side of the chip carrier, so that a medium can be supplied to the sensor chip from the second side of the chip carrier.

23. A production method of a covered sensor module, comprising:
arranging and connecting a sensor chip to a first side of a chip carrier;
introducing the chip carrier having the sensor chip into an injection mold, wherein the injection mold has a device wherein a region of a second side of the chip carrier opposite to the first side can be covered; and
at least partially covering the chip carrier having the sensor chip with a cover material;
forming a recess on the second side of the chip carrier opposite to the sensor chip.

24. The production method as claimed in claim 23, further comprising:
arranging a cooling structure in a region of the recess.

25. The production method as claimed in one of claim 24, further comprising:
forming a flow guiding device on a surface of the sensor module to dissipate heat from the surface of the sensor module.

26. The production method as claimed in claim 25,
providing the sensor module with a channel between the first side of the chip carrier and the sensor chip, the channel configured to connect a side of the sensor chip facing toward the first side of the chip carrier to a surrounding of the sensor module; and
keeping free the channel during the covering of the sensor module to form an opening in the cover.
